(19) United States
(12) Patent Application Publication
(10) Pub. No.: US 2015/0245741 A1
(43) Pub. Date: Sep. 3, 2015

(54) Grill System and Process

(71) Applicant: Aaron Fechter, Orlando, FL (US)

(72) Inventor: Aaron Fechter, Orlando, FL (US)

(21) Appl. No.: 14/195,811

(22) Filed: Mar. 3, 2014

(51) Int. Cl. A47J 37/07

(52) U.S. Cl. CPC A47J 37/0713; A47J 37/0786

(57) ABSTRACT

A grill is disclosed comprising at least at least one removable tube for receiving a fuel gas (preferably Hydrogen or the gas generated by underwater arcing between two electrodes), the one or more tubes in having at least one aperture disposed within the at least one tube, gas delivery means for delivering the fuel gas to the tubes, a grate positioned above the at least one tube such that food supported on the grate is in direct contact with flames emanating from the at least one aperture when the fuel gas is lit. The grill preferably comprises a “grid” of flames emanating from a plurality of adjacent tubes, blanketing food when gas is supplied to the tubes and lit. The food itself is supported or held within the flames with a grate coupled a distance atop the tire tubes. A process is also disclosed for uniformly cooked, lower-fat, juicy steaks.

### FIELD OF THE INVENTION

The invention is directed generally to a process and apparatus for grilling over direct flame with improved accuracy and improved resulting taste.

### COPYRIGHT

Copyright—A portion of the disclosure of this document contains material that is subject to copyright protection. The copyright owner has no objection to the facsimile reproduction by anyone of the patent document or the patent disclosure, as it appears in publically available Patent and Trademarks Office patent files or records, but otherwise reserves all copyright rights whatsoever. The following notice applies to the text and drawings that form a part of this document: Copyright Aaron Fechter, All Rights Reserved.

### BACKGROUND

Grills for cooking commonly make use of well know cooking gases, such as propane. These grills use the gas in order to create a flame which in turn produces heat for transfer of that heat to a burner surface, The heat from the burner then is used to raise the food temperature. sufficiently for cooking.

Grills of this variety may allow food to be “seared” which is generally thought to enhance flavor. “Searing” is defined in the Miriam Webster Dictionary as “cook[ing] the surface of (something, such as a piece of meat) quickly with intense heat.” Some believe this enhances flavor or meat, although a disadvantage of traditional searing on an ordinary grill is that usually creates a burned, tough outer layer on the meat.

Gases commonly used in gas grills include propane. In order for effective combustion of the propane to occur, the propane must be premixed with oxygen in order for the flame to burn blue at the burner outlet. If no oxygen is premixed with the propane, the flame will burn yellow, will be sooty, and the flame will be cooler (thus gas is wasted). The reason un-premixed propane produces soot upon burning is because propane that is not premixed with oxygen will combust incompletely—the soot is caused by carbon which has not combined with elemental oxygen. In other words, premixing with oxygen is required to provide sufficient oxygen for complete combustion (as evidenced by a blue flame). Because of the soot created during incomplete combustion of propane, blue flame burning grills are preferable. For this reason, all propane based gas grills will have a manner for premixing oxygen to produce blue flames.

### SUMMARY

Disclosed is a grill for providing precision cooking over a direct flame. The grill enables variable flame intensities on different portions of the grill. The grill is adapted for use with fuels which do not require premixing with oxygen to produce a blue flame. One advantage of the grill is that it enables food to be cooked so that it has a uniform charring, but which does not result in a tough exterior on the meat or other food cooked. To that end, this disclosure also encompasses a process for cooking food to provide improved taste and texture over traditional “searing.”

The grill comprises at least at least one removable tube for receiving a fuel gas, the one or more tubes in having at least one aperture disposed within the at least one tube, gas delivery means for delivering the fuel gas to the tubes, a grate positioned above the at least one tube such that food supported on the grate is in direct contact with flames emanating from the at least one aperture when the fuel gas is lit. The preferable configuration for the grill comprises a “grid” of flames emanating from a plurality of adjacent tubes. In this configuration, a grid of flames softly blanket at least the bottom portion of food when gas is supplied to the tubes and lit. The food itself is supported a short distance above the fire tubes such that the food is preferably held within the range of the flame's height (which varies based on the quantity of gas supplied to a particular fire tube) so that the food may be cooked in direct flame. This configuration, coupled with the use of the fuel mentioned above (preferably Hydrogen or the fuel gas created when an underwater arc is struck between two electrodes) results in food that is charred, but not tough. The steaks cooked in direct flame using the disclosed grill and fuel have an absorbent, tender surface char (unlike a traditional “seared” surface) and this difference allows more fat drippings to exit a piece of meat. Also, the fuels used are preferably those which do not require oxygen premixing, so the grill does not require any diffuser mechanism. The preferred fuels mentioned previously emit water when burned, so the combination of light charring and the use of the fuel on the grill results in a process for preparing a lower fat content, more juicy steak. It also generates an evenly cooked steak (or other meat). In the case of steaks, the resulting steak cooked using the disclosed process and grill does not have a color gradient in a cross section. For instance, instead of a medium steak cross section appearing brown at the edges and pink in the middle, the entire steak has an even pink color, with light charring on the external surface which was exposed to the direct flame.

The grill enables precision cooking in that each fire tube has a means for supplying a certain quantity of gas to the tube (for example plastic or rubber tubing directed to each fire tube, each in communication with an external fuel source). In the preferred embodiment, this means is a valve and valve knob coupled with an injector which is itself in removable communication with the fire tube. Benefits to this configuration are that thinner parts of a steak, for instance, can be cooked on a lower temperature. This is accomplished for example in setting the valve knob so that a smaller amount of gas can enter a fire tube that is under a thinner portion of the steak.

The mode and means for constructing the above grill are described in detail in the Detailed Description. Equivalents contemplated below are made part of this Summary.

### BRIEF DESCRIPTION OF THE DRAWINGS

FIG. 1 is an overhead view of the grill, in accordance with an embodiment.

FIG. 2 is a perspective view of the grill, in accordance with an embodiment.

FIG. 3 is an interior view of the grill, in accordance with an embodiment.

FIG. 4 shows the grill being used to cook a steak, and is an alternate view of the grill and the method used for cooking a steak, in accordance with an embodiment.

### DETAILED DESCRIPTION

Disclosed is a grill for providing precision cooking over a direct flame. The grill enables variable flame intensities on different portions of the grill. The grill is adapted for use with fuels which do not require premixing with oxygen to produce a blue flame. One advantage of the grill is that it enables food to be cooked so that it has a uniform charring, but which does not result in a tough exterior on the meat or other food cooked. To that end, this disclosure also encompasses a process for cooking food to provide improved taste and texture over traditional “searing.”

The grill differs from a Propane grill. In a Propane burning grill, the burner is below a heat diffuser plate or rocks so that the heat will be distributed as evenly as possible across the inside of the grill. In contrast, the present grill has no diffuser component (or oxygen pre-mixing component) and the burner is placed in close proximity to the grate that the meat sits on, so that the flames from the burning fuel actually touch the meat. This is possible without burning the meat due to the properties of the gas used in the grill.

The grill efficiently and effectively burns a unique fuel for the purpose of cooking food. This fuel may be preferably a clean burning fuel that produces water upon combustion. Examples are Hydrogen gas or even the fuel gas produced by underwater arcing between two electrodes as described in U.S. Pat. No. 6,299,738, now expired. For convenience, this gas will be referred to throughout this description as “Hydrogen” or simply “the gas,” however, this usage shall mean Hydrogen gas along with similar gases not requiring oxygen premixing. Hydrogen may be burned by other grills if proper alterations are made to the grill but its use in standard grills will not be as efficient or optimized for cooking precision and quality that is possible with the disclosed grill. There are several reasons that a new type of grill was developed for Hydrogen and similar fuels (collectively referred to as “Hydrogen” for convenience). The flames produced by Hydrogen are clean burning and need no air mixed with fuel before it leaves the burner, whereas a standard Propane or Natural Gas grill requires an air intake port just before the burner where the air and gas mix prior to the fuel being burned. In a standard grill, that air mixture must be set just right to mix with and to prevent partial combustion of Propane or Natural Gas, but the properties of Hydrogen do not require, nor would it benefit the combustion to allow air to mix with Hydrogen before combustion. Hydrogen burns completely, 100% combustion, with no air mixed with the fuel. The gas described for use with the Grill 100 is preferable to simply using propane because the flavor of foods cooked using the Grill 100 differs from propane grilled food. Propane injects a subtle flavor in meats, and some people can detect by taste whether a steak has been cooked with propane, for example.

Hydrogen flames, when adjusted to just touch the bottom of the meat, will “blossom” around the bottom surface of the meat, so instead of burning the meat, the flame lightly singes a wide area of the meat and generally provides gentle cooking to the interior of the meat. The singed, or charred effect on the meat produces a very flavorful meat. To ensure that the effect is accomplished across the entire surface of the meat, there are a multiplicity of flames located just under the bottom surface of the meat. The construction of the grill so as to accomplish these means is discussed in the paragraphs below. Together, this multiplicity of flames will form a blanket of fire under the meat, lightly, but thoroughly charring the outside of the meat, and leaving the inside of the meat gently cooked and easily managed to be the perfect temperature desired.

In addition, one property of Hydrogen and similar fuels is that it burns at a high temperature and creates water when burned which adds to the desirable cooking qualities of the fuel and infuses the meat with moisture as it cooks, which, is an improvement on overcooked, dried out meat which results from traditional searing and grilling techniques.

To accomplish the multiplicity of small flames just under the meat, The Grill 100 has one or a plurality of Fire Tubes 109 for receiving a combustible cooking gas the Fire Tubes 109 having one or a plurality of Fire Slots 111 for allowing gas to escape and burn. The Fire Tubes 109 are open at one end and closed at the other, forcing the gas to travel out the Fire Slots 111. The Fire Tubes 109 are preferably 5/8″ O. D. copper tubing (or other suitable heat resistant rigid material) with one or more Fire Slots 111 cut cross-longitudinally within the copper tubing to allow the gas to escape and be lit. However, other diameters may be used and are within the scope of this disclosure.

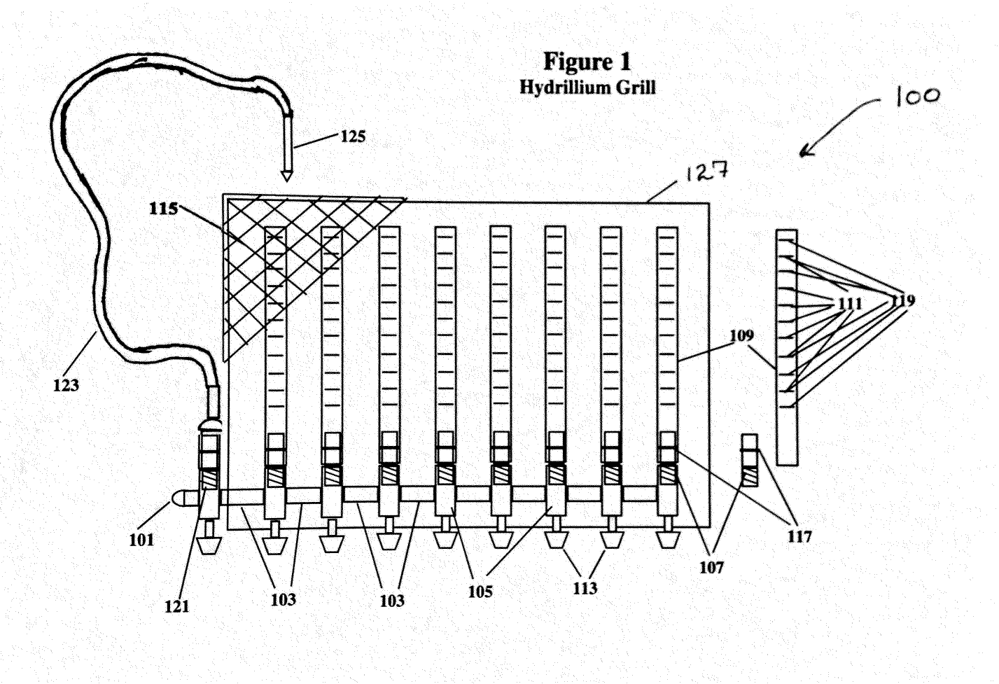

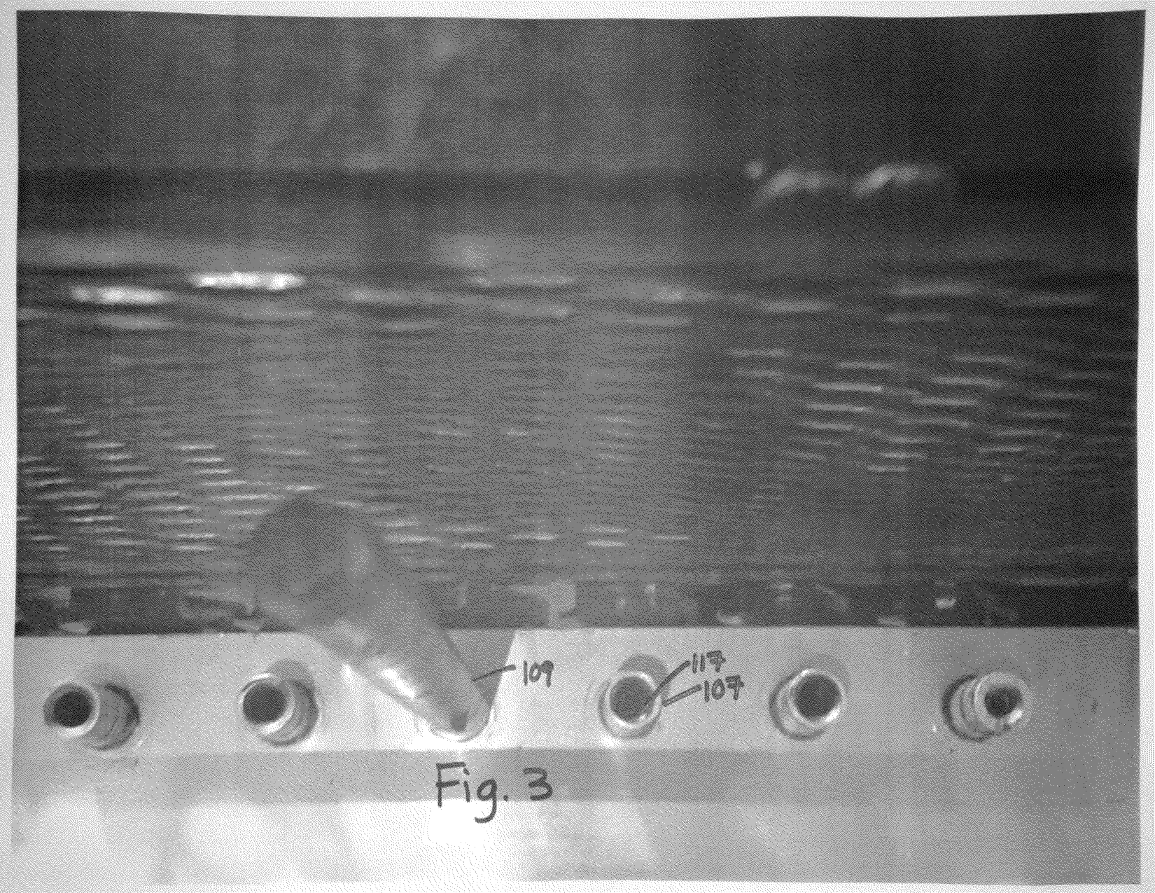

The Fire Tubes 109 are preferably in removable communication with Injectors 107 so that they may be slid by hand onto Injectors 107 within the framework of the Grill 100. The unique, removable design of the Fire Tubes 109 allows them to be easily disassembled from the Injectors for cleaning. The injectors themselves may be comprised of any suitable heat resistant material, such as Aluminum. Each of one or a plurality of Fire Tubes are preferably in slidable communication with a corresponding injector 107. Alternatively, the one or more Fire Tubes may be screwed into the injector, wherein both the Fire Tube 109 and Injector 107 have corresponding threading permitting the connection. In the embodiment depicted and visible in FIGS. 1 and 3, Injectors 107 have an O-Ring 117 that holds the Fire Tube 109 onto the injector 107 and keeps the gas from escaping before it reaches the Fire Slots 111.

When the gas comes out of Fire Slots 111 it may be ignited and the amount of gas being fed into the Fire Tube, and therefore the resulting height of the flames, may be adjusted by the Valve 105. Valve 105 is in communication with a corresponding Fire Tube 109 at one end and in communication with Valve Knob 113 at the other end. The one or more Valves 105 may be any suitable valve such as a Ball Valve. For example, WE Anderson® Brass Ball Valve, DBV-04 maybe used. The use of a Valve Knob 113, which may be any knob known in the art for adjusting valves, allows each Fire Tube to be individually controlled to produce the desired flame height. In some cases, one Fire Tube may be completely turned off so as to not have any flames whereas the adjacent Fire Tube may be turned on.

The tremendous amount of flexibility to turn on and off the various Fire Tubes allows for precision cooking never before imagined, so, for instance, thinner parts of a steak might not be cooked as long as thicker parts, or over as high of a Flame Point 119. Flame Point 119 for the purpose of this disclosure is refers to the point where the flame is located on the grill, and in particular, to the hottest part of the flame coming out of any particular slot. FIG. 1 shows where on the grill the Flame Points will occur, however not pictured in FIG. 1 are the actual flames or the hottest part of the flame. In accordance with a cooking method that is also described by virtue of this disclosure, the hottest point of the flame is the point that should be adjusted to touch the steak when cooking a steak, although cooler areas of the flame may also be used. This also, then, is the critical factor that influences the exact height positioning of the Fire Tubes. In other words, the Fire Tubes are positioned at a distance below an overlaying Grate 115, the distance corresponding to the height of a blue flame that is emitted from the Fire Slots 111 such that food placed on the Grate 115 will be in direct contact with the flames.

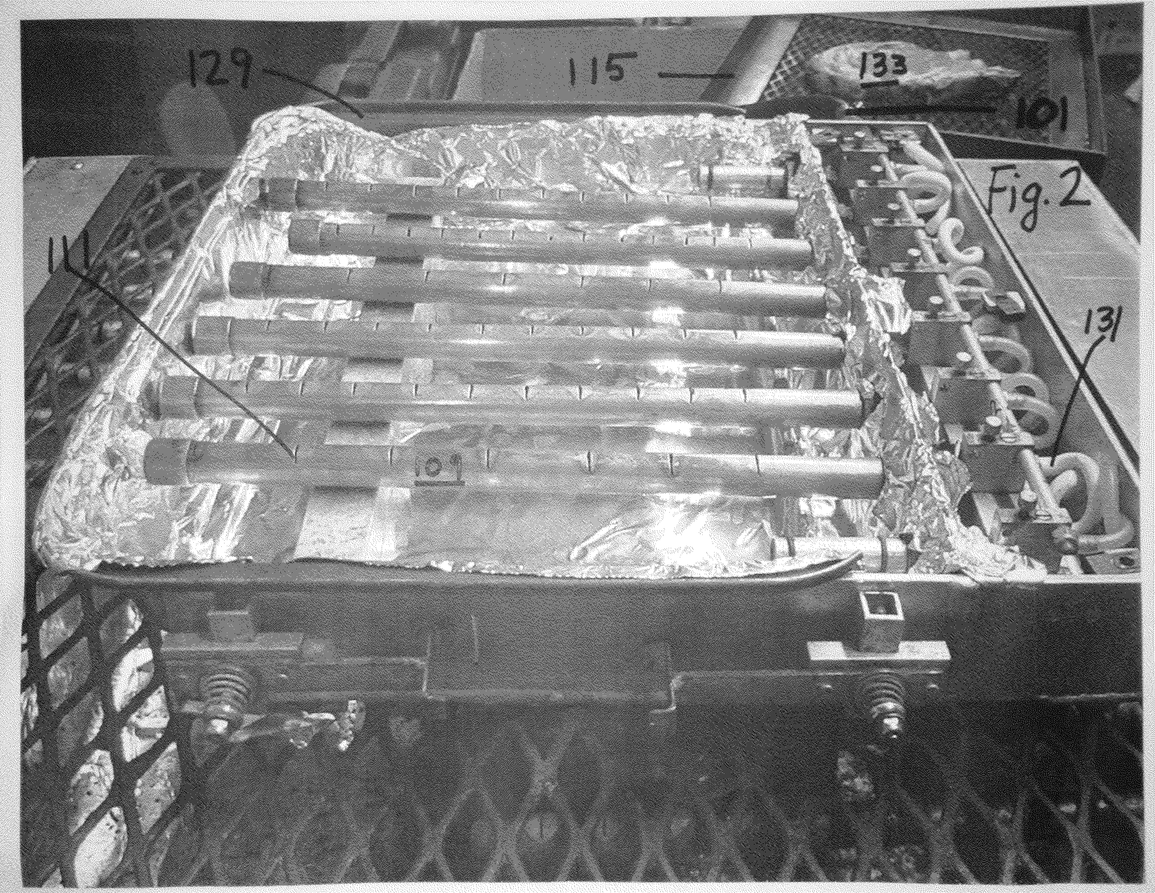

In the embodiment shown in FIG. 2, the Fire Tubes 109 and corresponding injectors 107 are ¾ inch below the Grate 115. A one inch flame, coming out of a Fire Tube positioned ¾ of an inch below the meat is approximately ideal for a steak. It should be noted that the Fire Tubes 109 may be adjustable so as to allow further cotnbinations of flame height and distance from Fire Tubes for various cooking procedures that will be developed by chefs who use this product.

The array of Flame Points 119 creates a grid of fire with flames all fairly close to each other, precision adjusted via Valves 107/Valve Knobs 113 for the food they are touching, resulting in more evenly and perfectly cooked food. This flexibility also allows the chef to control how much gas is used so that none is wasted when there is no meat or other food on a particular portion of the Grill 100. This is not possible with conventional grills that do not have as much control over the precise place that heat will be delivered.

The Injectors 107 are screwed into individual Valves 105 that control the amount of gas delivered to each of the Injectors. As shown in FIG. 2, each Valve 105 is fed by Gas Tubes 131 (in communication with Gas Connector 101, itself in communication with a gas source) such that each Valve 105 may be independently adjusted for the amount of gas delivered to the corresponding Fire Tube 109 by the adjustment of the corresponding Valve Knob 113. Gas Tubes 131 may be any suitable tubing, such as plastic or rubber tubing. An example is Superthane® 2000383 tubing.

The Valves 105 are connected to a Manifold Assembly 103 that provides structural stability for the Valves 105 as well as a delivery system for the gas into all of the Valves 105. The components of the Grill 100 (such as the Manifold Assembly 103, Valves 105, and Fire Tubes 109, each in communication as shown in FIGS. 1 and 2) are preferably supported by and mounted to a Support 127, which may be a rectangular open box, preferably configured to collect cooking debris, such as grease or fallen food.

The Manifold Assembly 103 is fed by a Gas Connector 101 which is connected (not shown) to a source of regulated Hydrogen or similar gas such as Hydrogen at a pressure, typically of 5 to 20 PSI. Gas Connector 101 may be a Quick Disconnect air fitting (ex. Parker 1B10021 NPT), however similar connectors may be employed.

Covering the array of Fire Tubes 105 is preferably a Grate 115 for supporting food to be cooked in the direct flame and capable of withstanding high temperatures, such as cast iron or similar metal. The Grate 115 should be as open as possible while still able to support food, and allowing the flames to touch the food as described above. One such material for the Grate 115 is expanded metal, but any kind of grate desired may be used. The embodiment shown uses a custom made expanded steel grate 115, however a Weber brand grate, Model #7525 may be used as well as other similar grates. For the purposes of illustration, only a corner of the Grate 155 is shown in FIG. 1, however it is understood Grill 100 would have a Grate 115 that covers Fire Tubes 105. Grate 115 is also preferably a removable, grate. As shown in FIG. 2, a steak 133 (or other food) may be placed on the Grate 115 in the kitchen and simply set atop the Fire Tubes 115, preferably just above the Fire Tubes 105. In the embodiment pictured, Lip 129 is positioned ¾″ above the Fire Tubes 109, so that the Grate may be positioned ¾″ above the Fire Tubes 109.

A Hydrogen Grill may be set up with any number of Fire Tubes 109 as needed for the application and in any arrangement. The Manifold 103 may also be set up in many different ways as this arrangement shown is typical and only for the purposes of illustration.

It should be noted that the Grill 100 may be more conveniently cleaned than its traditional grill counterparts. Because the Fire Tubes 109 are preferably removable as individual components, they are easily cleaned, fitting easily in most kitchen sinks as would an ordinary indoor appliance. This is unlike other grills, which are left out doors where the remaining food particles attract bugs and rats—and which allow previously cooked food to get on subsequently cooked food unless meticulously scrubbed. Another benefit of this construction, and a more subtle difference, is that the majority of the intense heat is all upward onto the grill surface rather than the entire grill body make it easy to clean. In the embodiment pictured, support 127 is shallow and may be lined with a removable material, such as aluminum foil and simply discarded after cooking. This also aids in cleaning, as a user does not have to reach down into a large grill cavity, which may be very hot, to remove a Fire Tube—which would risk burning the user's arm.

Various modifications may be made to the disclosed grill without departing from the spirit of the invention. For instance, a Fire Tube 109 may have various numbers of Fire Slots 111. For instance, a Fire Tube may only one slot or hole in it to precisely cook the very middle of a steak. Another alternative is the addition of a Handheld Torch 125 may be affixed to the Grill 100 for touch up work on the meat or other food being cooked. If a section of the meat appears to need a little more charring, or you wish to give the edges a char, or to more thoroughly cook or char any spot on the meat, this unique torch may be used by the cook to accomplish that end. The fuel flow through this torch is directed and metered by Special Handheld Torch Valve/Injector Assembly 121 which may be conveniently located outside the frame of the grill so as not to interfere with the Grate 115. The fuel flows through the Tube For Handheld Torch 123 into the Handheld Torch 125. As mentioned previously, this disclosure also includes a process for cooking food. Part of this disclosure is the recognition that searing food does not actually produce the results that the cooking community believes it does. In particular, searing meat has been uniformly regarded as a manner for moisture to be “locked in” to a cut of meat, resulting in a juicier meat. Also, some people enjoy the charred flavor caused by searing.

The problem with searing meat on traditional grills is that the seared surface is a layer of tough, hardened meat that is difficult to chew, especially if it covers a significant portion of the meat. Also, the meat is actually not nearly as juicy as meat cooked on the Grill 100. A process for cooking food so as to produce a uniform charring without toughness requires the food to be cooked in a direct Hydrogen (or similar fuel) flame, using a device for positioning the flames across the entire surface of the food, such as the Grill 100 disclosed herein. Using a fuel such as Hydrogen allows the entire surface to be charred, while at the same time releasing water vapor during cooking. For the purpose of this example, a steak is used, although it is understood that any meat or food may be used. Unlike “seared” steak, fats are allowed to leave the steak, yet the resulting steak is juicier and has a more tender surface and interior than a traditionally prepared grilled steak.

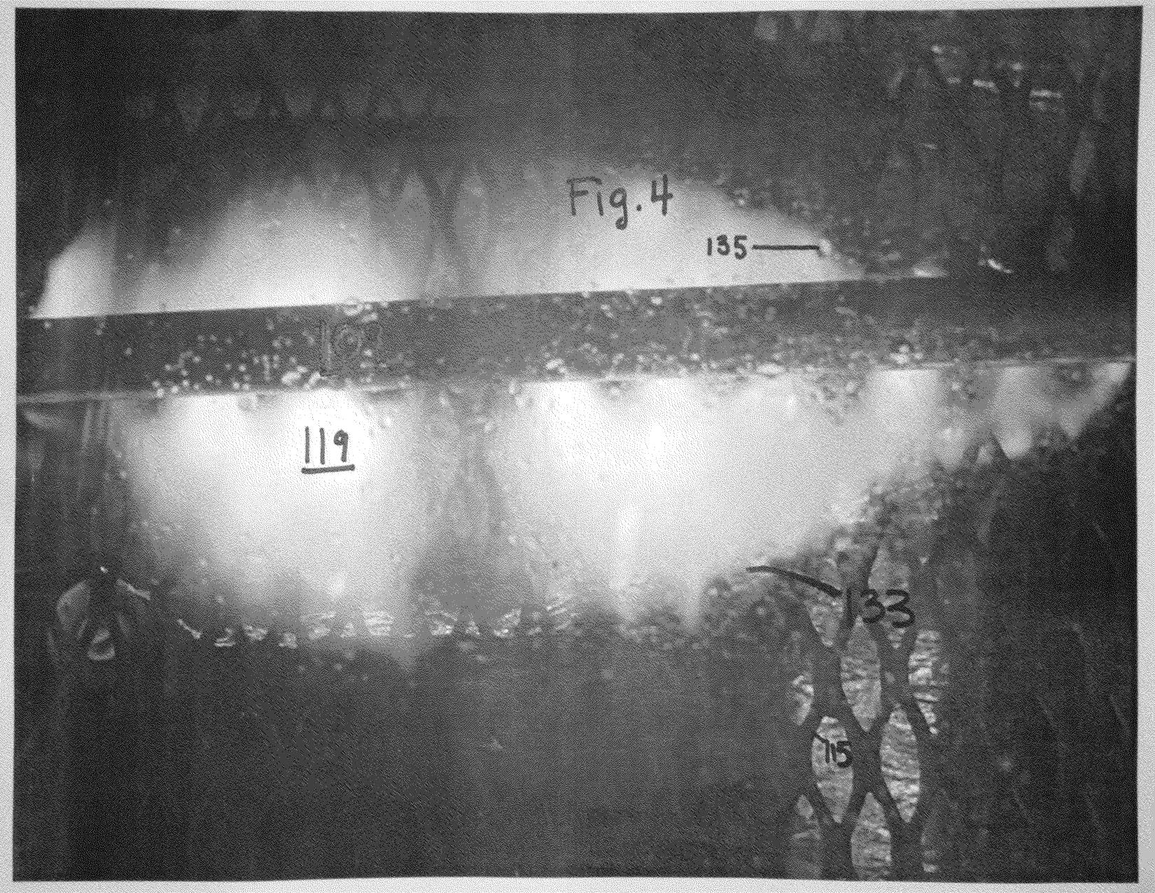

It should be noted that one advantage of the Grill 100 is that it improves over both propane grilling and cooking over an open fire. FIG. 4 is an image of a cooking steak as viewed from the underside. The horizontal bar in that Figure is a Fire Tube 109. (For larger steaks, the steak may be cooked over more than one Fire Tube). The benefit of the present grill, which preferably uses a “grid” of flames emanating from the Fire Slots, is that the steak in this Figure is blanketed with a soft fire. The grill improves over open fire cooking because the grid structure localizes the fire to the steak, as shown FIG. 4. In open fire cooking, the fire can dance on and off the meat and take much longer to cook. Further, the fuels described herein would not be present in a traditional open fire pit. For example, Hydrogen and the fuel generated by underwater arcing produce water when burning. This property is one of the reasons meats cooked using the Grill 100 have a juiciness to an extent not present in foods cooked using an open fire pit.

Steaks which have been cooked using the Grill 100 have a soft, absorbent char on the outside of the steak. It is not a thick hard char as seen when a steak is seared using previous grills or searing devices. The absorbent, soft nature of the steak exterior cooked in this fashion allows more fat droplets (example droplet 135) to fall from the steak than a steak which has been “sealed” by whole or partial searing. As a result, grilling over the Grill 100 using the fuels described herein also constitutes a process for preparing steaks having a lower fat content when cooked. Another surprising advantage is that steaks prepared using Grill 100 are actually juicer than seared steaks, despite the common notion that searing steaks “locks in” a meat's juices.

Further, steaks prepared using the Grill 100 are evenly cooked throughout the steak. For example, a traditionally seared steak cooked medium will have a well done exterior fading into a gradually pink interior. Steaks cooked on the disclosed Grill 100 are evenly cooked and do not have this interior color gradient. For instance, a steak cooked medium on the Grill 100 have a cross section color that is nearly unithrmly pink, whereas a traditionally grilled steak will have a cross section having a brown exterior and pink interior.

The foregoing has been a detailed description of two preferred embodiments of the device, however, various modifications and equivalents can be made without departing from the scope and spirit of the invention.

1. A grill comprising
at least one removable tube for receiving a fuel gas, the one or more tubes in having at least one aperture disposed within the at least one tube,
gas delivery means for delivering the fuel gas to the tubes;
a grate positioned above the at least one tube such that food supported on the grate is in direct contact with flames emanating from the at least one aperture when the fuel gas is lit;

2. The grill as in claim 1, further comprising a plurality of tubes, each tube in communication with separately adjustable gas delivery means for delivering variable quantities of the fuel gas to the tubes.

3. The grill as in claim 2, wherein the plurality of tubes have a plurality of equally spaced apertures disposed along the topmost surface of each tube.

4. The grill as in claim 1 or 2, further comprising a support in communication with the at least one tube and gas delivery means.

5. The grill as in claim 4 wherein the support further comprises a heat resistant rigid support having a base and sides adapted to receive food debris caused when the grill is in use.

6. The grill as in claim 4, wherein the fuel gas comprises a gas which does not require premixing with oxygen to produce a blue flame upon being lit.

7. The grill as in claim 6, wherein the fuel gas comprises Hydrogen.

8. The grill as in claim 6, wherein the fuel comprises a gas created during underwater arcing between two electrodes.

9. The grill as claim 1 or 2 or 3 wherein the gas delivery means further comprises
an injector in removable communication with each tube, the injector in communication with a valve and valve control means for regulating the quantity of gas delivered to each tube.

10. A process for cooking food comprising
placing the food in direct contact with one or more flames from lighted fuel gas, the fuel gas comprising the fuel gas as in claim 6, 7, or 8;
wherein the food is placed in direct contact with said flames using the grill as in claim 1, 2, or 3.

11. The process as in claim 10, wherein at least the bottom portion of the food is in direct contact with the hottest portion of the flames.
